(19) United States
(12) Patent Application Publication
(10) Pub. No.: US 2014/0077502 A1
(43) Pub. Date: Mar. 20, 2014

(54) METHOD AND APPARATUS FOR GENERATIVE MOTIVE AND ELECTRIC POWER BY USING BUOYANCY FORCE

(71) Applicant: Isao Suzuki, Chiba (JP)

(72) Inventors: Isao Suzuki, Chiba (JP); Kouei Asato, Uruma (JP)

(73) Assignee: Isao Suzuki, Chiba (JP)

(21) Appl. No.: 14/031,886

(22) Filed: Sep. 19, 2013

Related U.S. Application Data
(60) Provisional application No. 61/703,070, filed on Sep. 19, 2012.

(51) Int. Cl. F03B 13/10

(52) U.S. Cl. CPC F03B 13/10
USPC 290/54

(57) ABSTRACT

A buoyancy force power generation apparatus for producing motive and electric power, includes: a system housing which is a vertically standing cylindrical tower in which a liquid is stored thereby forming a liquid section from its bottom and a gas section over the liquid section; a plurality of floatation members each being connected with one another to form a chain like moving trace within the system housing; a drive shaft having receptacle pins to engage with pins formed on the floatation members to convert an up-down movement of the floatation members to a rotational movement of the drive shaft; a gas supply opening to supply a compressed gas into a desired number of the floatation members at a lower position of the system housing; and an electric power generator connected to the drive shaft to generate electric power by utilizing the rotational movement of the drive shaft.

### CROSS-REFERENCE TO RELATED APPLICATION

This application claims priority to provisional application No. 61/703,070 filed Sep. 19, 2012, the disclosure of which is hereby incorporated by reference herein in its entirety.

### FIELD OF THE INVENTION

This invention relates to power generation using buoyancy force, and more particularly, this invention relates to a method and apparatus for generating motive and electric power using buoyancy forces of water and air, thereby substantially permanently generating clean energy. The forces of buoyancy are created by a series of rotationally engaged floatation members to transmit a displacement force, i.e., a motive power, to a drive shaft rotatably connected to an electric power generator, thus, continuously generating the electric power.

### BACKGROUND OF THE INVENTION

The disclosure of this specification is directed to a method and apparatus to generate clean energy. As known, industrialized countries throughout the world in the twentieth and twenty first centuries have an increased requirement for energy proportional to their populations and production of products for national and international consumption. Conventionally, water power such as dams and fossil fuels such as oil and gas, have provided the world with their main source of energy for industry and for ever more energy dependent populations.

In the present days, the energy is mainly created by using a large amount of fossil fuels, which leads to exhaustion of resources, pollution of environment, ozone layer depletion, and global warming, etc. Power generation using nuclear pauses a serious problem when an accident happens. Other types of power generation, such as solar power, geothermal power, hydropower, wind power, wave power, are able to produce energy, however an efficiency of such power generation is not very high. Now, struggles are going on all over the world for better positions to acquire the fossil fuels. There are rural areas in the world where electricity is still not available.

With the increase in the world's population and the industrial output of new industrialized nations such as China and India, combined with ever decreasing natural energy resources, there is an increasing need to find alternate energy sources. It is preferable if such alternative energy sources are non-polluting due to the theory of global warming from burning fossil fuels and the problems with pollution that oil cause in the world's environment. As a result, greater emphasis is increasingly being placed on creating more efficient mechanical devices which either operate more efficiently, or which produce energy, in an attempt to conserve current resources. It is currently being recognized that many alternative energy sources exist such as wind power, solar energy, which are being under utilized. Further, many potential non-polluting, renewable natural energy resources, such as gravity and geothermal energy, are currently under exploited.

There is an ongoing need for new energy sources which take advantage of naturally available sources. Such a device should therefore be provided that will harness the energy provided by the natural upward rise of floatation members and other components which displace sufficient water or fluid and allow for recompressing of such floatation members with minimal energy loss to thereby provide a net gain in upward force which may be harnessed.

To overcome the above noted problems, it is absolutely necessary to a new type of power generation that can be pollution-free and can be easily installed everywhere through a metropolitan area to a rural area, and on the ocean, river, lake, etc. The new power generation can be operated with substantially no fuel expenses, and thus low cost, thereby can be rapidly used everywhere by everyone.

### SUMMARY OF THE INVENTION

It is, therefore, an object of the present invention to provide a method and apparatus for continuously generating motive and electric power based on buoyancy forces achieved by using water and air without needs of fuel expenses.

It is another object of the present invention to provide a method and apparatus for continuously generating motive and electric power based on buoyancy forces generated by floatation members filled with gas and rotate around a predetermined path in the liquid in a vertical direction.

It is a further object of the present invention to provide a method and apparatus for continuously generating motive and electric power based on buoyancy forces caused by liquid and gas so that the electric power generation can be achieved anywhere with any scales.

One aspect of the present invention is a buoyancy force power generation apparatus for generating motive and electric power substantially permanently. The buoyancy force power generation apparatus includes: a system housing which is a vertically standing cylindrical tower in which a liquid is stored thereby forming a liquid section from its bottom and a gas section over the liquid section; a plurality of floatation members each being connected with one another and forming a chain like moving trace within the system housing; a drive shaft having receptacle pins to engage with pins formed on the floatation members to convert an up-down movement of the floatation members to a rotational movement of the drive shaft; a gas supply opening to supply a compressed gas into a desired number of the floatation members at a lower position of the system housing; and an electric power generator connected to the drive shaft to generate electric power by utilizing the rotational movement of the drive shaft.

In the buoyancy force power generation apparatus of the present invention, the compressed gas is filled in the floatation members in the liquid section so that the floatation members move upward by a buoyancy force to produce the rotational energy on the drive shaft in one direction while the compressed gas filled in the floatation members is exhausted to the gas section when the floatation members arrive at about a highest position of the moving trace.

In the buoyancy force power generation apparatus of the present invention, an opening of each of the floatation members faces downward at about a bottom of the moving trace where the compressed gas is provided thereto, and the opening of each of the floatation members faces upward at about a top of the moving trace where the compressed air is exhausted.

In the buoyancy force power generation apparatus of the present invention, the compressed gas is provided to the floatation members from a compressor through the gas supply opening, and wherein the compressor is driven by an external source at a start of operation of the buoyancy force power generation apparatus, and once the operation starts, the compressor is driven by a part of the electric power generated by the buoyancy force power generation apparatus.

In the buoyancy force power generation apparatus of the present invention, the chain like moving trace of the floatation members is supported by an upper generator wheel and a lower generator wheel vertically aligned with one another in the system housing where the drive shaft is formed at a center of the upper generator wheel. In another embodiment, the chain like moving trace of the floatation members is supported by a single generator wheel formed at an upper position of the system housing and a pipe like flow path configured by a lower part of the system housing where the drive shaft is formed at a center of the single generator wheel. In a further embodiment, the chain like moving trace of the floatation members is supported by a pipe like flow path configured by the system housing where the drive shaft is formed at about a highest position of the flow path.

In the buoyancy force power generation apparatus of the present invention, a plurality of power generator systems operate in parallel at the same time where each of the power generator systems is configured by a plurality of floatation members and a system housing forming the chain like moving trace of the floatation members substantially established in the liquid section, and the drive shaft is connected to the plurality of power generator systems.

The buoyancy force power generation apparatus of the present invention further includes an air turbine on the system housing which is driven by the gas exhausted from the plurality of floatation members at the gas section of the system housing via gas exhaustion opening to produce a rotational force which is transmitted to the drive shaft thereby increasing the electric power generated by the electric power generator.

The buoyancy force power generation apparatus of the present invention further includes a wind turbine at a top of a structure of the power generation apparatus which is driven by wind power obtained at an outside of the structure to produce a rotational force or electric power, thereby increasing an overall amount of the electric power generated by the electric power generator.

The buoyancy force power generation apparatus of the present invention further includes a solar panel at a top of a structure of the power generation apparatus which is driven by solar energy obtained at an outside of the structure to produce electric power, thereby increasing an overall amount of the electric power generated by the electric power generator.

Another aspect of the present invention is a buoyancy force power generation method for generating motive and electric power substantially permanently. The power generation method comprising the following steps of: forming a system housing which is a vertically standing cylindrical tower in which a liquid is stored thereby forming a liquid section from its bottom and a gas section over the liquid section; providing a plurality of floatation members each being connected with one another and forming a chain like moving trace within the system housing; providing a drive shaft having receptacle pins to engage with pins formed on the floatation members to convert an up-down movement of the floatation members to a rotational movement of the drive shaft; supplying a compressed gas into a desired number of the floatation members at a lower position of the system housing via a gas supply opening; and generating electric power by an electric power generator connected to the drive shaft by utilizing the rotational movement of the drive shaft.

According to the present invention, the resources to produce the energy are merely air and water, that can be available anywhere, thus extremely low cost. Unlike the energy obtained by using a chemical process or burning fuels, this invention causes no exhaustion gas, no air pollution, and no global warming, and thus, safe and easy. Once the system starts, it operates continuously and substantially permanently, thereby constantly and stably producing the energy. The power generator of this invention can be constructed in both a small scale and a large scale, everywhere through a metropolitan area to a rural area, on the ocean, river, lake, etc. It is unnecessary to involve in the struggles for obtaining the energy resources.

### BRIEF DESCRIPTION OF THE DRAWINGS

The present invention together with the above and other advantages may best be understood from the following detailed description of the embodiments of the invention illustrated in the drawings below.

FIGS. 1A and 1B show an example of structure of the first embodiment of the buoyancy force motive and electric power generator of the present invention in which FIG. 1A is a front view thereof and FIG. 1B is a side view thereof.

FIGS. 2A and 2B show an example of structure of the second embodiment of the buoyancy force motive and electric power generator of the present invention in which FIG. 2A is a front view thereof and FIG. 2B is a side view thereof.

FIGS. 3A and 3B show an example of structure of the third embodiment of the buoyancy force motive and electric power generator of the present invention in which FIG. 3A is a front view thereof and FIG. 3B is a side view thereof.

FIGS. 4A-4D show an example of structure of the fourth embodiment of the buoyancy force motive and electric power generator of the present invention incorporating air turbine in which FIG. 4A is a front view thereof, FIG. 4B is a side view thereof, FIG. 4C is a top view thereof, and FIG. 4D is a schematic diagram related to FIG. 4C to show an example of air flows in air turbines.

FIGS. 5A-5C show an example of structure of the fifth embodiment of the buoyancy force motive and electric power generator of the present invention incorporating wind turbines and/or solar panels in which FIG. 5A is a front view thereof, FIG. 5B is a side view thereof, and FIG. 5C is a top view thereof.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

This invention relates to power generation using buoyancy force, and more particularly, to a power generating method and apparatus for generating motive and electric power using buoyancy forces of water and air, thereby generating clean energy substantially permanently.

The power generating method and apparatus herein described and disclosed, utilizes the natural power of buoyancy to provide an upward movement of a series of bellowed floatation members and a unique manner of circulating the floatation members on a flow path typically having a generator wheel that includes a drive shaft having receptacle guide pins, to produce a driving force in a vertical direction which may be mechanically connected to drive an electric power generator.

As is well known, a floating body or member, such as a sealed hollow container, when held below the surface of water, and then released, will rise vertically upwards toward the surface. It is also conventionally known that the water exerts an upward force on the floatation member according to the Archimedes principle. This principle provides that the magnitude of the upward force exerted onto the floatation members is equal to the weight of water which is displaced by the volume of the floatation members.

Further, if the total volume of a floatation member displaces water weighing less than the member itself, that member will sink. Especially, in the present invention, to promote to produce the upward force onto the floatation members, compressed air is provided to the floatation members at a lower position of a system housing in the water. The forces of buoyancy are created by a series of rotationally engaged floatation members to transmit a displacement force, i.e., a motive power in a vertical direction, to a drive shaft typically formed at a center of a generator wheel and rotatably connected to an electric power generator, thus, continuously generating the electric power.

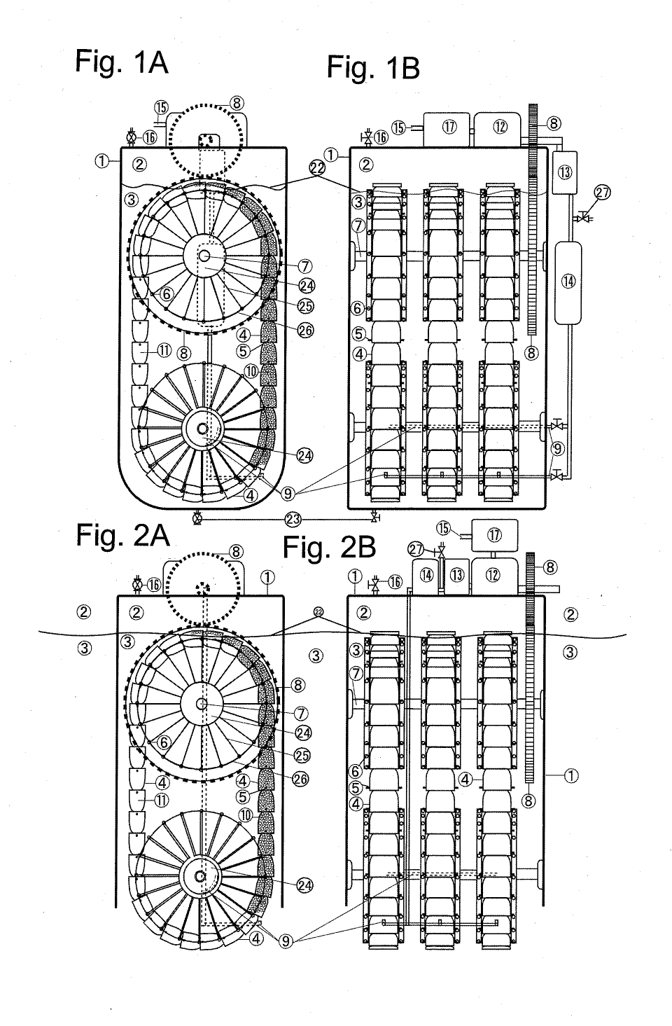

FIGS. 1A and 1B show an example of structure of the first embodiment of the buoyancy force motive and electric power generator implementing the present invention. FIG. 1A is a front view of the buoyancy force motive and electric power generator, and FIG. 1B is a side view of the buoyancy force motive and electric power generator. In the first embodiment, a power generator system is mainly configured by two generator wheels and a plurality of floatation members rotatably provided along outer peripherals of the two generator wheels in a manner of chain.

As can be seen in FIG. 1B, in this example, three power generator systems are installed in parallel with one another in a system housing 1 where the system housing 1 in this case may be a square tower. There is formed of a liquid section 3 from the bottom to an upper position of the system housing 1 and a gas section 2 at the top of the system housing 1. The top of the liquid section 3 is a surface of water designated by a reference numeral 22 at the upper position of the system housing 1 and an area above the liquid surface 22 is the gas section 2. The system housing 1 must be built strong enough to endure the pressure of the liquid since the inner pressure will increase when the height of the power generator system increases. At the top of the system housing 1, a gas exhaustion opening 16 is provided to exhaust the compressed gas accumulated in the gas section 2.

As is known, a traditional water wheel having water buckets obtains the rotational energy by using downward forces of the buckets when the water falls on the buckets. The present invention works in a manner reverse to such a water wheel, i.e., it obtains the rotational energy by using upward buoyancy forces of the buckets. For achieving this, a generator wheel is provided in the system housing 1 filled with liquid and a plurality of flotation members 4 each being connected with one another in a manner similar to the water wheel are mounted on the generator wheel.

In the example of FIGS. 1A and 1B, two generator wheels are provided in a vertical relationship, i.e., an upper generator wheel and a lower generator wheel. The upper generator wheel has a drive shaft 7 to transmit a rotation force produced by the buoyancy force to gears 8 to drive an electric power generator 12. In this example, the first gear 8 is connected to the drive shaft 7 of the driving wheel and the second gear 8 engaging with the first gear 8 is connected to the electric power generator 12.

Further, in this example, an air supply opening 9 is connected between an area of the drive shaft 7 of the lower generator wheel and an accumulator 14 provided at the outside of the system housing 1. The accumulator 14 accumulates and stores the compressed gas (air) from a compressor 13 also provided at the outside of the system housing 1. Instead of the compressor 13, the compressed gas can be supplied to the accumulator 14 from other device via a compressed gas supply valve 27. The output of the electric power generator 12 can be directly used or can be connected a battery 17 to store the electric energy where a reference numeral 15 indicates an output terminal.

The floatation members 4 are designed such that each is able to receive a gas, typically an air, when it is in the liquid at the lower position of the system housing 1. The floatation members 4 are connected like a chain to rotate along the outer rim of the generator wheels in one direction while changing the posture. Each of the floatation members 4 in the liquid section is arranged in a direction that can receive the gas at a predetermined lower position in the system housing 1 so that buoyancy forces of the gas in the floatation members 4 within the liquid are produced which generates the rotational energy on the generator wheel.

For doing this, the floatation member 4 is basically a container typically having a bucket like shape to contain therein the gas or liquid via its opening. Thus, the shape of each of the floatation members can be conical, elliptical cone, bucket shape, manger shape, etc. When in operation, the chain of the floatation members move along a trace vertically formed by the two driving wheels where the trace is typically an elliptical shape.

The plurality of floatation members 4 move along the trace as shown in FIG. 1A in which a reference numeral 10 indicates the situation where the floatation member contains the liquid whereas a reference numeral 11 indicates the situation where the floatation member contains the gas. The chain of floatation members 4 are so arranged that the opening of each of the floatation members faces downward at the bottom of the trace of the chain movement, i.e., the lowest position of the lower driving wheel in the system housing. In contrast, the opening of each of the floatation members faces upward at the top of the trace of the chain movement, i.e., the highest position of the upper driving wheel in the system housing. At about the lowest position, the floatation member 4 is filled with the compressed gas, and at about the highest position, the compressed gas is exhausted from the floatation member 4.

At the start of the operation, an external device such as the compressor 13 and the accumulator 14 provide the compressed gas to the desired floatation members 4 via the gas supply opening 9. Because of the buoyancy force of the gas filled in the floatation members 4, the generator wheel rotates because the flotation members 4 filled with the gas move upward, thereby producing the rotational energy on the drive shaft 7. The rotational energy of the drive shaft 7 is transmitted to the electric power generator 12 through the gears 8, thereby generating the electric power.

After that, by using a portion of the motive power and the electric power obtained through the rotational energy, it is possible to repeatedly provide the compressed gas to the floatation members 4. In other words, once the operation of the buoyancy force motive and electric power generator starts, it is unnecessary to operate the compressor 13 and accumulator 14 by an external force. Therefore, the rotational energy can be continuously produced by the motive and electric power generator by itself, thereby enabling to generate the motive and electric power substantially permanently.

To convert the buoyancy force received by the floatation members 4, i.e., the up-down movements, to the rotational energy of the drive shaft 7 of the driving wheel, each of the floatation members 4 includes a pin 5 that engages with a receptacle (guide) pin 6 formed on the upper driving wheel to receive the pin 5. When the floatation member 4 moves upward, the pin 5 contacts the receptacle pin 6 on the driving wheel to press the receptacle pin 6 upward. This operation is repeated for the corresponding pair of the pin 5 and the receptacle pin 6, thereby rotating the driving wheel (drive shaft 7). In this example, the driving wheel further includes a drum 24 and spokes 5 for achieving mechanical strength, and a guide ring 26 on which the plurality of the receptacle pins 6 are mounted.

As noted above, in the buoyancy force motive and electric power generator of the present invention, it is designed that the gas is securely filled in the floatation members 4 in the liquid section 3 so that the floatation members 4 move upward to produce the rotational energy in one direction. In the system housing 1, since the liquid is filled up to a position correspond to the highest position that the floatation members 4 can reach, when the floatation member 4 gradually changes the direction at the highest position, the gas (air) filled in the floatation member 4 is exhausted. Then, the floatation member 4 gradually receives the liquid (water) while moving downwardly in the liquid section 3. In contrast, the floatation member 4 in the lower position is filled with the new gas to establish the buoyancy force. By repeating the filling and exhausting operation of the liquid and gas for the floatation members 4, the rotational energy can be continuously generated.

In the buoyancy force motive and electric power generator, it is necessary to provide the compressor 13 to supply the gas to the floatation members 4 so that they move upward. The power that drives the compressor 13 is provided by a compressor driver formed outside of the system housing 1, however, such a compressor driver can activated by a part of the electric power generated by the buoyancy force motive and electric power generator of the present invention once its operation is activated, thereby supplying the gas to each of the floatation members 4. Alternatively, the rotational energy retrieved from the buoyancy force motive and electric power generator can be directly provided to the compressor 13 to supply the gas to each of the floatation members 4.

The amount of motive power and the electric power that will be generated is determined by the rotational torque which corresponds to a capacity of the floatation member, a number of floatation members incorporated, a diameter of the gear, and a number of same systems constructed in parallel. As seen, the example of FIGS. 1A and 1B is a three-parallel system in which three power generator systems operate in parallel at the same time. The drive shaft 7 is commonly connected to the three power generator systems. Although one of the gears 8 is provided at the inside of the system housing 1, it is also possible to provide the gear 8 at the outside. Within the system housing 1, since the floatation members 4 circulate in one direction, the liquid in the system housing 1 also circulates in the same direction, thus, when the floatation members 4 change the moving direction and move downward, there is substantially no resistance against the downward movement of the floatation members 4.

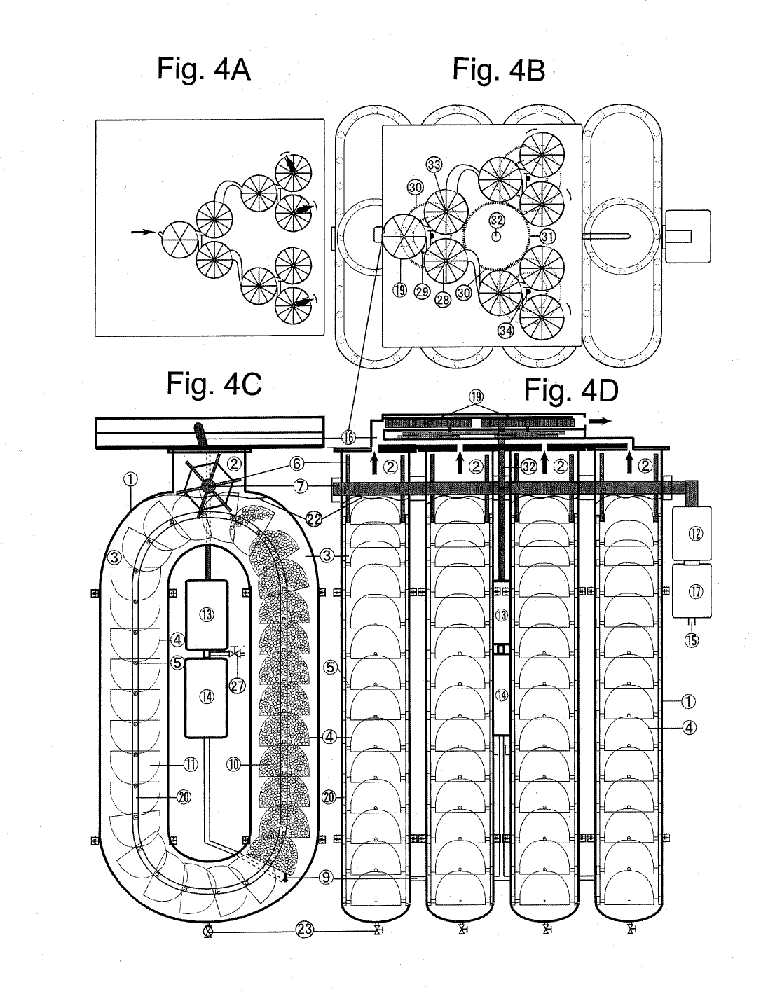

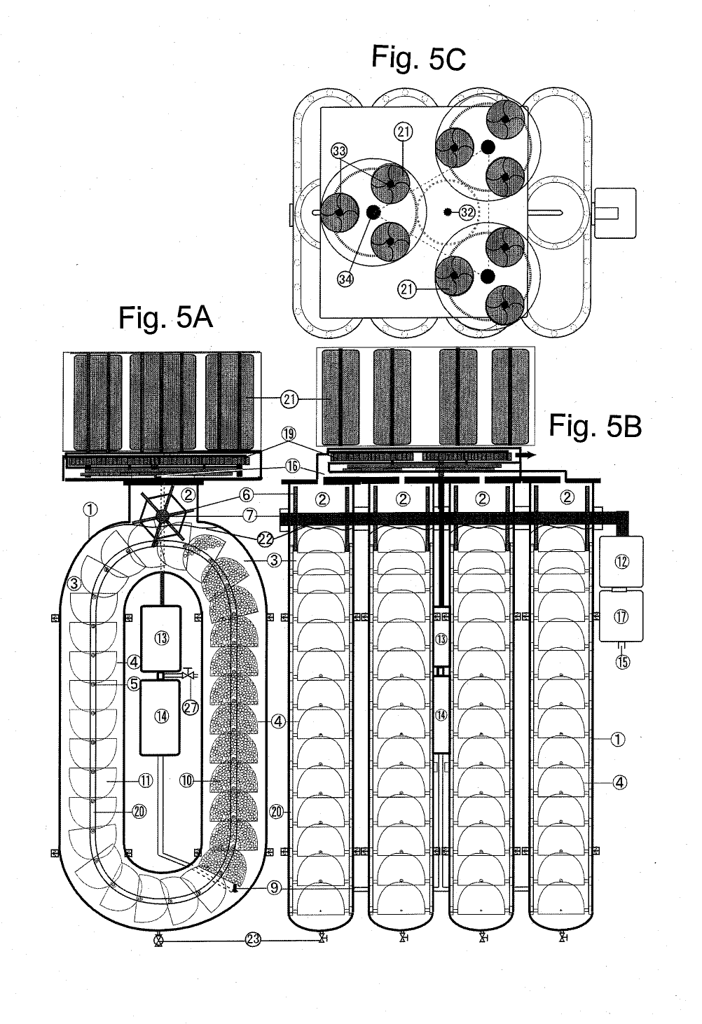

As noted above, the system hosing 1 is filled with liquid up to the uppermost position of the flotation members 4, and the remaining upper area of the system housing is a section for the gas. At the start of operation, the floatation members 4 of a desired number are filled with the gas from the outside through the gas supply opening 7. By the buoyancy force, the floatation members filled with the gas move upward and change direction along the trace of chain movement so that the floatation members exhaust the gas to the system housing when they are inclined and reversed. By the gas exhausted in this manner, the gas in the upper area in the system housing 1 is compressed and can be exhausted through the gas exhaustion opening 16 to be used to drive an air turbine as will be described later with reference to FIGS. 4A-4D and 5A-C.

The above noted movements of the floatation members 4 cause the rotational movement of the drive shaft 7 and the gears 8 which is used for generating the electric power. This movement of the floatation members 4 connected with one another continue, thereby enabling to obtain the motive power and electric power substantially permanently. The system housing 1 includes a water supply and drain opening 23 which can be used to supply the water in the system housing 1 when the water is reduced or to drain the water for maintenance of the power generator system.

FIGS. 2A and 2B show an example of structure of the second embodiment of the buoyancy force motive and electric power generator implementing the present invention. FIG. 2A is a front view of the buoyancy force motive and electric power generator, and FIG. 2B is a side view of the buoyancy force motive and electric power generator. Similar to the first embodiment, in the second embodiment, a power generator system is mainly configured by two generator wheels and a plurality of floatation members rotatably provided along outer peripherals of the two generator wheels in a manner of chain. Further, similar to the example of FIGS. 1A and 1B, in the second embodiment, three power generator systems are installed in parallel with one another in the system housing 1 as shown in FIG. 2B. The drive shaft 7 is commonly connected to the three power generator systems.

Similar to FIGS. 1A and 1B, in the example of FIGS. 2A and 2B, there is formed of a liquid section 3 from the bottom to an upper position of the system housing and a gas section 2 at the top of the system housing 1. The top of the liquid section 3 is a surface of water designated by a reference numeral 22 at the upper position of the system housing 1 and an area above the liquid surface 22 is the gas section 2. The system housing 1 must be built strong enough to endure the pressure of the liquid since the inner pressure will increase when the height of the power generator system increases.

The operation of the embodiment of FIGS. 2A and 2B is basically the same as that of the first embodiment. Namely, at the start of the operation, an external device such as the compressor 13 and the accumulator 14 provide the compressed gas to the desired floatation members 4 via the gas supply opening 9. Because of the buoyancy force of the gas filled in the floatation members 4, the generator wheel rotates because the flotation members 4 filled with the gas move upward, thereby producing the rotational energy on the drive shaft 7. The rotational energy of the drive shaft 7 is transmitted to the electric power generator 12 through the gears 8, thereby generating the electric power.

After that, by using a portion of the motive power and the electric power obtained through the rotational energy, it is possible to repeatedly provide the compressed gas to the floatation members 4. In other words, once the operation of the buoyancy force motive and electric power generator is started, it is unnecessary to operate the compressor 13 and accumulator 14 by an external force. Therefore, the rotational energy can be continuously produced by the motive and electric power generator itself, thereby enabling to generate the motive and electric power substantially permanently.

In the second embodiment, the major difference from the first embodiment is that it is a floating type so that the bottom part of the power system is open and thus the power generator system can be established on ocean, river, lake, etc. to utilize the water there. The upper part of the system housing 1 is closed so that the compressed gas that accumulated at the gas section 2 can be introduced to the outside via the gas exhaustion opening 16 to drive the turbine, etc. as shown in FIGS. 4A-4D and 5A-5C. Since the system housing 1 is on the ocean, lake, river, etc., it is preferable to establish the compressor 13 and the accumulator 14 at the top of the system housing 1 rather than the side thereof. Further, the system housing 1 should be anchored to the ground so that the power generator system will not submerge or flow away.

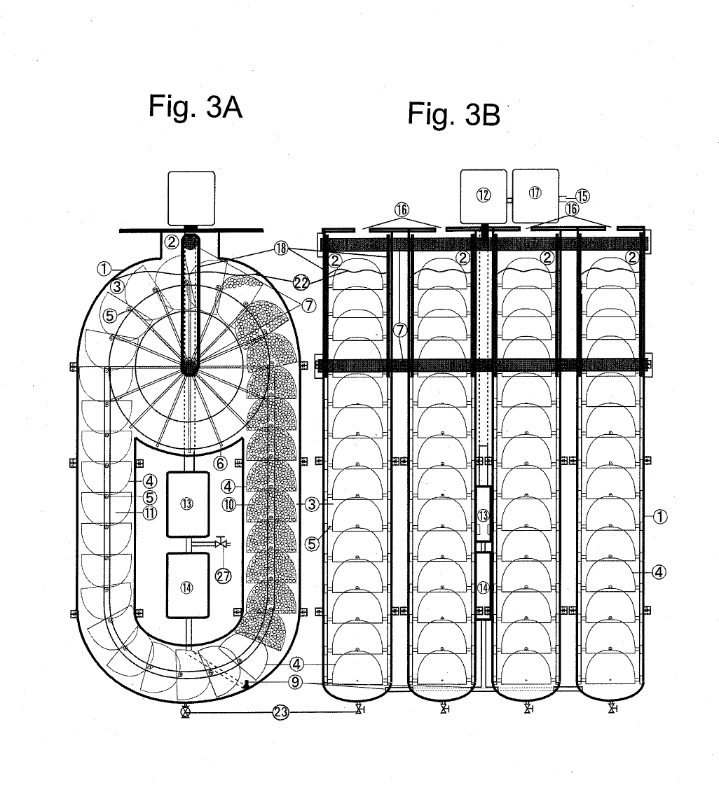

FIGS. 3A and 3B show an example of structure of the third embodiment of the buoyancy force motive and electric power generator implementing the present invention. FIG. 3A is a front view of the buoyancy force motive and electric power generator, and FIG. 3B is a side view of the buoyancy force motive and electric power generator. In the third embodiment, a power generator system is mainly configured by a single generator wheel and a plurality of floatation members 4 rotatably provided along the outer peripheral of the generator wheel and the water path formed by the system housing 1. Namely, the lower part of the system housing 1 is shaped like a pipe so that the flotation members 4 at the lower part of the housing move along the pipe of the system housing 1. Further, similar to the first and second embodiments, a plurality of power generator systems, in this case, four power generator systems are formed in parallel with one another to increase the output power as shown in FIG. 3B. The drive shaft 7 is commonly connected to the four power generator systems.

Similar to the first and second embodiments, in the example of FIGS. 3A and 3B, there is formed of a liquid section 3 from the bottom to an upper position of the system housing 1 and a gas section 2 at the top of the system housing 1. The top of the liquid section 3 is a surface of water designated by a reference numeral 22 at the upper position of the system housing 1 and an area above the liquid surface 22 is the gas section 2. The system housing 1 must be built strong enough to endure the pressure of the liquid since the inner pressure will increase when the height of the power generator system increases.

In the third embodiment, the major difference from the first and second embodiments is that a single generator wheel is used rather than two generator wheel, and a lower part of the system housing is configured like a pipe as noted above. The single generator wheel has a drive shaft 7 to transmit the rotational energy produced by the buoyancy forces of the flotation members 4 to the gears 8 and electric power generator 12. Within the system housing 1, since the floatation members 4 circulate in one direction through the pipe like formed at the lower portion of the system housing 1, the liquid in the system housing 1 also circulates in the same direction, thus, when the floatation members 4 change the moving direction and move downward, there is substantially no resistance against the downward movement of the floatation members 4.

Another difference from the first and second embodiments is that the compressor 13 and the accumulator 14 are provided in the space created between the pipe like flow paths. This is because at least the lower part of the system housing 1 is separated into four pipe like water paths, thus, a space for the compressor 13 and the accumulator 14 is available in a manner shown in FIGS. 3A and 3B. Further, in this example, the drive shaft 7 and the electric power generator 12 are connected via a belt or a chain as designated by a reference numeral 18 to transmit the rotational energy.

The operation of the embodiment of FIGS. 3A and 3B is basically the same as that of the first and second embodiments. Namely, at the start of the operation, an external device such as the compressor 13 and the accumulator 14 provide the compressed gas to the desired floatation members 4 via the gas supply opening 9. Because of the buoyancy force of the gas filled in the floatation members 4, the generator wheel rotates because the flotation members 4 filled with the gas move upward, thereby producing the rotational energy on the drive shaft 7. The rotational energy of the drive shaft 7 is transmitted to the electric power generator 12 through the belt 18, thereby generating the electric power.

After that, by using a portion of the motive power and the electric power obtained through the rotational energy, it is possible to repeatedly provide the compressed gas to the floatation members 4. In other words, once the operation of the buoyancy force motive and electric power generator is started, it is unnecessary to operate the compressor 13 and accumulator 14 by an external force. Therefore, the rotational energy can be continuously produced by the motive and electric power generator itself, thereby enabling to generate the motive and electric power substantially permanently.

FIGS. 4A-4D show an example of structure of the fourth embodiment of the buoyancy force motive and electric power generator implementing the present invention. FIG. 4A is a front view of the buoyancy force motive and electric power generator, FIG. 4B is a side view of the buoyancy force motive and electric power generator, FIG. 4C is a top view of the buoyancy force motive and electric power generator, and 4C is a schematic diagram related to the top view of FIG. 4C to show an example of air flows in turbines. In the fourth embodiment, a power generator system is mainly configured by system housings 1 each being configured as a water flow path having a pipe like shape, a drive shaft 7, a plurality of floatation members 4 rotatably provided along the water flow path of the system housing 1. Namely, the driving wheel shown in FIGS. 1A-1B, 2A-2B and 3A-3B is not used in the fourth embodiment of the present invention. Each of the system housings 1 is shaped like a pipe so that the flotation members 4 in the system housing 1 move along the water flow path having the pipe shape in a vertical direction. Further, similar to the third embodiment, four power generator systems are formed in parallel with one another to increase the output power as shown in FIG. 4B. The drive shaft 7 is commonly connected to the four power generator systems.

Similar to the foregoing embodiments, in the example of FIGS. 4A-4D, there is formed of a liquid section 3 from the bottom to an upper position of the system housing 1 and a gas section 2 at the top of the system housing 1. The top of the liquid section 3 is a surface of water designated by a reference numeral 22 at the upper position of the system housing 1 and an area above the liquid surface 22 is the gas section 2. The system housing 1 must be built strong enough to endure the pressure of the liquid since the inner pressure will increase when the height of the power generator system increases.

In the fourth embodiment, the major difference from the first to third embodiments is that no generator wheel is included in the system housing 1 and a drive shaft 7 is provided at the top of the system housing 1. The drive shaft 7 has a plurality of receptacle pins 6 which are arranged in an interval and length to fit with pins 5 formed on the corresponding floatation members 4 so that the buoyancy force of the floatation member 4 is transmitted to the drive shaft 7. The drive shaft 7 can be directly connected to the electric power generator 12 as shown in FIG. 4B. Within the system housing 1, since the floatation members 4 circulate in one direction through the pipe water flow path of the system housing 1, the liquid in the system housing 1 also circulates in the same direction, thus, when the floatation members 4 change the moving direction and move downward, there is substantially no resistance against the downward movement of the floatation members 4.

Another difference from the foregoing embodiments is that air turbines 19 are formed at the top of the buoyancy force motive and electric power generator of the present invention. During the operation, the floatation members 4 of a desired number are filled with the compressed gas through the gas supply opening 9. By the buoyancy force, the floatation members 4 filled with the gas move upward and change direction along the trace of the pipe like water path so that the floatation members 4 exhaust the gas to the system housing 1 when they are inclined and reversed. By the gas exhausted in this manner, the gas in the upper area in the system housing 1 is compressed and can be exhausted through the gas exhaustion opening 16 to be used to drive the air turbines 19.

The operation of the embodiment of FIGS. 4A-4D is basically the same as that of the first and second embodiments. Namely, at the start of the operation, an external device such as the compressor 13 and the accumulator 14 provide the compressed gas to the desired floatation members 4 via the gas supply opening 9. Because of the buoyancy force of the gas filled in the floatation members 4, the drive shaft 7 rotates because the flotation members 4 filled with the gas move upward. The rotational energy of the drive shaft 7 is transmitted to the electric power generator 12, thereby generating the electric power.

After that, by using a portion of the motive power and the electric power obtained through the rotational energy, it is possible to repeatedly provide the compressed gas to the floatation members 4. In other words, once the operation of the buoyancy force motive and electric power generator is started, it is unnecessary to operate the compressor 13 and accumulator 14 by an external force. Therefore, the rotational energy can be continuously produced by the motive and electric power generator itself, thereby enabling to generate the motive and electric power substantially permanently.

Further, the compressed gas from the gas exhaustion opening 16 is used to drive the air turbine 19 which is also connected to the drive shaft 7 and the electric power generator 12 to further improve the efficiency in the power generation in the present invention. FIG. 4C mainly shows a top view of an example of the air turbine 19 which includes a group of gears 28-31 and a main gear 32 and turbine shafts 33 and 34. The main gear 32 engages with the drive shaft 7 as shown in FIG. 4B to ultimately transmit the power generated by the air turbine 19 to the electric power generator 12. FIG. 4D is a top view showing an example of air flows involved in the air turbine 19.

FIGS. 5A-5C show an example of structure of the fifth embodiment of the buoyancy force motive and electric power generator implementing the present invention. FIG. 5A is a front view of the buoyancy force motive and electric power generator, FIG. 5B is a side view of the buoyancy force motive and electric power generator, and FIG. 5C is a top view of the buoyancy force motive and electric power generator. In the fifth embodiment, a power generator system is mainly configured by a system housing 1 configured as a water flow path having a pipe like shape, a drive shaft 7, a plurality of floatation members rotatably provided along the water flow path of the system housing 1, an air turbine 19, and wind turbines 21 (alternatively, solar panels 21).

Similar to the embodiment shown in FIGS. 4A-4D, the fifth embodiment includes the air turbine 19 to advantageously utilize the compressed air exhausted from the floatation members 4 via the gas exhaustion opening 16. Namely, during the operation, the floatation members 4 of a desired number are filled with the compressed gas through the gas supply opening 9. By the buoyancy force, the floatation members 4 filled with the gas move upward and change direction along the trace of the pipe like water paths of the system housing 1 so that the floatation members 4 exhaust the gas to the gas section 2 when they are inclined and reversed.

By the gas exhausted in this manner, the gas in the upper area in the system housing 1 is compressed and can be exhausted through the gas exhaustion opening 16 to be used to drive the air turbines 19. For this purpose, although not shown, the fifth embodiment also includes the main gear 32 shown in FIG. 4C to transmits the power generated by the air turbine 19 to the drive shaft 7. Thus, the power generated by the air turbine 19 is ultimately provided to the electric power generator 12 via the drive shaft 7 to increase the overall power generated by the buoyancy force motive and electric power generator of the present invention.

Four system housings 1 each being structured similar to that of the fourth embodiment are employed to produce the motive and electric power by a parallel operation of four power generator systems. Namely, the driving wheel shown in FIGS. 1A-1B, 2A-2B and 3A-3B is not used in the fifth embodiment of the present invention. Each of the system housings 1 is shaped like a pipe so that the flotation members 4 in the system housing 1 move along the water flow path having the pipe shape. The drive shaft 7 is commonly connected to the four power generator systems.

Similar to the foregoing embodiments, in the example of FIGS. 4A-4D, there is formed of a liquid section 3 from the bottom to an upper position of the system housing 1 and a gas section 2 at the top of the system housing 1. The top of the liquid section 3 is a surface of water designated by a reference numeral 22 at the upper position of the system housing 1 and an area above the liquid surface 22 is the gas section 2. Each of the system housings 1 must be built strong enough to endure the pressure of the liquid since the inner pressure will increase when the height of the power generator system increases.

In the fifth embodiment, the major difference from the first to third embodiments is that no generator wheel is included in the system housing 1 and a drive shaft 7 is provided at the top of the system housing 1. The drive shaft 7 has a plurality of receptacle pins 6 which are arranged in interval and length to fit with a pin 5 formed on each of the floatation members 4 so that the buoyancy force of the floatation member 4 is transmitted to the drive shaft 7. The drive shaft 7 can be directly connected to the electric power generator 12 as shown in FIG. 5B. Within the system housing 1, since the floatation members 4 circulate in one direction through the pipe water flow path of the system housing 1, the liquid in the system housing 1 also circulates in the same direction, thus, when the floatation members 4 change the moving direction and move downward, there is substantially no resistance against the downward movement of the floatation members 4.

Another difference from the foregoing embodiments is that the wind turbines 21 (or solar panels 21) are formed at the top of the buoyancy force motive and electric power generator of the present invention. The wind turbines (or solar panels) 21 are formed on the top of the structure of the buoyancy force motive and electric power generator to make full use of the structure. The wind turbines 21 convert the wind power to the electric power, and the solar panels 21 convert the solar energy to the electric power. Although the wind turbines (or solar panels) 21 are not directly related to the operation based on the buoyancy force, the resultant power generated by the wind turbines (or solar panels) 21 is supplied to the battery 17 to combine with the electric power generated by the buoyancy force.

The operation of the embodiment of FIGS. 5A-5C is basically the same as that of the first and second embodiments. Namely, at the start of the operation, an external device such as the compressor 13 and the accumulator 14 provide the compressed gas to the desired floatation members 4 via the gas supply opening 9. Because of the buoyancy force of the gas filled in the floatation members 4, the drive shaft 7 rotates because the flotation members 4 filled with the gas move upward. The rotational energy of the drive shaft 7 is transmitted to the electric power generator 12, thereby generating the electric power.

After that, by using a portion of the motive power and the electric power obtained through the rotational energy, it is possible to repeatedly provide the compressed gas to the floatation members 4. In other words, once the operation of the buoyancy force motive and electric power generator is started, it is unnecessary to operate the compressor 13 and accumulator 14 by an external force. Therefore, the rotational energy can be continuously produced by the motive and electric power generator itself, thereby enabling to generate the motive and electric power substantially permanently. Further, as noted above, the wind turbines (or solar panels) 21 are formed on the top of the structure of the buoyancy force motive and electric power generator to make full use of the structure. The power generated by the wind turbines (or solar panels) 21 is supplied to the battery 17 to combine with the electric power generated by the buoyancy force.

As has been described above, according to the present invention, the resources to produce the energy are merely air and water, that can be available anywhere, thus extremely low cost. Unlike the energy obtained by using a chemical process or burning fuels, this invention causes no exhaustion gas, no air pollution, and no global warming, and thus, safe and easy. Once the system starts, it operates continuously and substantially permanently, thereby constantly and stably producing the energy. The power generator of this invention can be constructed in both a small scale and a large scale, everywhere through a metropolitan area to a rural area, on the ocean, river, lake, etc. It is unnecessary to involve in the struggles for obtaining the energy resources.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A buoyancy force power generation apparatus for generating motive and electric power, comprising:
a system housing which is a vertically standing cylindrical tower in which a liquid is stored thereby forming a liquid section from its bottom and a gas section over the liquid section;
a plurality of floatation members each being connected with one another and forming a chain like moving trace within the system housing;
a drive shaft having receptacle pins to engage with pins formed on the floatation members to convert an up-down movement of the floatation members to a rotational movement of the drive shaft;
a gas supply opening to supply a compressed gas into a desired number of the floatation members at a lower position of the system housing; and
an electric power generator connected to the drive shaft to generate electric power by utilizing the rotational movement of the drive shaft.

2. A buoyancy force power generation apparatus as defined in claim 1, wherein the compressed gas is filled in the floatation members in the liquid section so that the floatation members move upward by a buoyancy force to produce the rotational energy on the drive shaft in one direction while the compressed gas filled in the floatation members is exhausted to the gas section when the floatation members arrive at about a highest position of the moving trace.

3. A buoyancy force power generation apparatus as defined in claim 1, wherein an opening of each of the floatation members faces downward at about a bottom of the moving trace where the compressed gas is provided thereto, and the opening of each of the floatation members faces upward at about a top of the moving trace where the compressed air is exhausted.

4. A buoyancy force power generation apparatus as defined in claim 1, wherein the compressed gas is provided to the floatation members from a compressor through the gas supply opening, and wherein the compressor is driven by an external source at a start of operation of the buoyancy force power generation apparatus, and once the operation starts, the compressor is driven by a part of the electric power generated by the buoyancy force power generation apparatus.

5. A buoyancy force power generation apparatus as defined in claim 1, wherein the chain like moving trace of the floatation members is supported by an upper generator wheel and a lower generator wheel vertically aligned with one another in the system housing where the drive shaft is formed at a center of the upper generator wheel.

6. A buoyancy force power generation apparatus as defined in claim 1, wherein the chain like moving trace of the floatation members is supported by a single generator wheel formed at an upper position of the system housing and a pipe like flow path configured by a lower part of the system housing where the drive shaft is formed at a center of the single generator wheel.

7. A buoyancy force power generation apparatus as defined in claim 1, wherein the chain like moving trace of the floatation members is supported by a pipe like flow path configured by the system housing where the drive shaft is formed at about a highest position of the flow path.

8. A buoyancy force power generation apparatus as defined in claim 1, wherein a plurality of power generator systems operate in parallel at the same time where each of the power generator systems is configured by a plurality of floatation members and a system housing forming the chain like moving trace of the floatation members substantially established in the liquid section, and wherein the drive shaft is connected to the plurality of power generator systems.

9. A buoyancy force power generation apparatus as defined in claim 2, further comprising an air turbine on the system housing which is driven by the gas exhausted from the plurality of floatation members at the gas section of the system housing via gas exhaustion opening to produce a rotational force which is transmitted to the drive shaft thereby increasing the electric power generated by the electric power generator.

10. A buoyancy force power generation apparatus as defined in claim 9, further comprising a wind turbine at a top of a structure of the power generation apparatus which is driven by wind power obtained at an outside of the structure to produce a rotational force or electric power, thereby increasing an overall amount of the electric power generated by the electric power generator.

11. A buoyancy force power generation apparatus as defined in claim 9, further comprising a solar panel at a top of a structure of the power generation apparatus which is driven by solar energy obtained at an outside of the structure to produce electric power, thereby increasing an overall amount of the electric power generated by the electric power generator.

12. A buoyancy force power generation method for generating motive and electric power, comprising the following steps of:
forming a system housing which is a vertically standing cylindrical tower in which a liquid is stored thereby forming a liquid section from its bottom and a gas section over the liquid section;
providing a plurality of floatation members each being connected with one another and forming a chain like moving trace within the system housing;
providing a drive shaft having receptacle pins to engage with pins formed on the floatation members to convert an up-down movement of the floatation members to a rotational movement of the drive shaft;
supplying a compressed gas into a desired number of the floatation members at a lower position of the system housing via a gas supply opening; and
generating electric power by an electric power generator connected to the drive shaft by utilizing the rotational movement of the drive shaft.
